(19) United States
(12) Patent Application Publication
(10) Pub. No.: US 2016/0349561 A1
(43) Pub. Date: Dec. 1, 2016

(54) LIQUID CRYSTAL DISPLAY DEVICE

(71) Applicant: Japan Display Inc., Tokyo (JP)

(72) Inventors: Hideki SHIINA, Tokyo (JP); Junko NAGASAWA, Tokyo (JP); Masato SHIMURA, Tokyo (JP)

(21) Appl. No.: 15/158,941

(22) Filed: May 19, 2016

(30) Foreign Application Priority Data
Jun. 1, 2015 (JP) 2015-111322

(51) Int. Cl. G02F 1/1339; G02F 1/1335; G02F 1/1368

(52) U.S. Cl. CPC G02F 1/13394; G02F 1/1368; G02F 1/133512; G02F 2201/56

(57) ABSTRACT

A liquid crystal display device has a liquid crystal display panel that includes a thin-film transistor (TFT) substrate having pixels formed thereon in a matrix pattern and a counter substrate, the two substrates having liquid crystal sandwiched therebetween to constitute a display area having a periphery encircled by a frame area. The display area has a first axis and a second axis perpendicular to the first axis. The liquid crystal display panel is curved along the first axis. The gap between the TFT substrate and the counter substrate is determined by columnar spacers formed on the counter substrate in a manner corresponding to positions of a black matrix over the counter substrate. The center of each of the columnar spacers is displaced in the first axis direction from the center of each of the corresponding positions of the black matrix.

### CLAIM OF PRIORITY

The present application claims priority from Japanese Patent Application JP 2015-111322 filed on Jun. 1, 2015, the content of which is hereby incorporated by reference into this application.

### BACKGROUND OF THE INVENTION

1. Field of the Invention

The present invention relates to a display device. More particularly, the invention relates to a liquid crystal display device having a curved screen.

2. Description of the Related Art

Liquid crystal display devices are generally configured to have a thin-film transistor (TFT) substrate disposed opposite to a counter substrate with liquid crystal sandwiched therebetween, the TFT substrate having pixel electrodes and TFTs formed thereon in a matrix pattern for example. The display device forms an image by suitably controlling the light transmission factor of liquid crystal molecules for each pixel. The liquid crystal display device usually has a flat screen.

However, some usages of the liquid crystal display device such as in-vehicle use invoke the need for a cylindrically curved screen, for example. That is because the curved screen, in some cases, is easier to view and also facilitates the layout of the display device in conjunction therewith.

JP-A-2013-130639 discloses a rubbing method for use on curved panels. In this case, panels are already bent when they are in the manufacturing process. JP-A-2008-175914 discloses a technique by which a thermoplastic sealant is used to prevent stress generation when panels are subjected to the bending process. In this case, too, the panels are bent in the manufacturing process. JP-A-2008-134537, JP-A-2008-111890, and JP-A-2004-354468 disclose other examples of curved display panels.

### SUMMARY OF THE INVENTION

With a view to achieving higher productivity, liquid crystal display panels are generally manufactured as follows: A large number of liquid crystal panels are first formed on a mother substrate. Upon completion of the mother substrate, the individual liquid crystal panels are separated from that substrate. When separated from the mother substrate, each liquid crystal panel is shaped flat. If curved display devices are each manufactured by having a flat liquid crystal display panel bent upon installation onto the product, the productivity of the liquid crystal display panels will not drop.

Meanwhile, diverse kinds of stress are generated when the flat display panel is bent into a curved shape. That is, the liquid crystal display panel has liquid crystal sandwiched between the TFT substrate and the counter substrate using a sealant. When the liquid crystal display panel is bent into a curved shape, deformation occurs differently in the TFT substrate and in the counter substrate. The gap between the TFT substrate and the counter substrate is determined using columnar spacers, for example. When the liquid crystal display panel is bent, the difference in deformation between the TFT substrate and the counter substrate affects the columnar spacers differently.

It is therefore an object of the present invention to provide a liquid crystal display panel that has a flat liquid crystal display panel bent into a curved shape with a minimum of deformation to prevent image quality degradation on the curved display panel.

The present invention proposes achieving the above object using the typical means outlined below.

(1) According to one embodiment of the present invention, there is provided a liquid crystal display device having a liquid crystal display panel that includes a TFT substrate having pixels formed thereon in a matrix pattern and a counter substrate. The TFT substrate and the counter substrate have liquid crystal sandwiched therebetween to constitute a display area of which a first axis is perpendicular to a second axis thereof. The display area is curved along the first axis. The gap between the TFT substrate and the counter substrate is determined by columnar spacers formed on the counter substrate. The columnar spacers are formed at positions corresponding to a black matrix on the counter substrate. The center of each of the columnar spacers is displaced from the center of each of the corresponding positions of the black matrix in the direction of the first axis.

(2) According to another embodiment of the present invention, there is provided a liquid crystal display device having a liquid crystal display panel that includes a TFT substrate having pixels formed thereon in a matrix pattern and a counter substrate. The TFT substrate and the counter substrate have liquid crystal sandwiched therebetween to constitute a display area of which a first axis is perpendicular to a second axis thereof. The display area is curved along the first axis. The TFT substrate has a first bar spacer formed thereon, the first bar spacer having a long side dimension thereof oriented in the direction of the first axis or the second axis. The counter substrate has a second bar spacer formed thereon, the second bar spacer having a long side dimension thereof oriented in the direction of the second axis or of the first axis in a manner crossing the first bar spacer when viewed in a plan view. The first bar spacer or the second bar spacer having the long side dimension thereof oriented in the first axis direction is longer than the first bar spacer or the second bar spacer having the long side dimension thereof oriented in the second axis direction.

(3) According a further embodiment of the present invention, there is provided a liquid crystal display panel including a TFT substrate having first pixels formed thereon in a matrix pattern and a counter substrate having second pixels formed thereon in a manner corresponding to the first pixels. The TFT substrate and the counter substrate have liquid crystal sandwiched therebetween to constitute a display area of which a second axis is perpendicular to a first axis thereof. The liquid crystal display panel is used as bent into a curved shape along the first axis. The center of each of the second pixels in the direction of the first axis is displaced from the center of each of the first pixels in the first axis direction.

(4) According to an even further embodiment of the present invention, there is provided a liquid crystal display device having a liquid crystal display panel that includes a TFT substrate having pixels formed thereon in a matrix pattern and a counter substrate. The TFT substrate and the counter substrate have liquid crystal sandwiched therebetween to constitute a display area of which a first axis is perpendicular to a second axis thereof. The display area is curved along the first axis. The gap between the TFT substrate and the counter substrate is determined by columnar spacers formed on the counter substrate. The ratio of the contact area of each of the columnar spacers in contact with the TFT substrate decreases progressively from the center of the display area toward the periphery of the display area.

### BRIEF DESCRIPTION OF THE DRAWINGS

FIG. 1 is a perspective view of a liquid crystal display device according to the present invention;

FIG. 2 is a cross-sectional view of a liquid crystal display panel;

FIG. 3 is a cross-sectional view of a curved liquid crystal display panel;

FIG. 4 is a cross-sectional view showing a process for manufacturing a curved liquid crystal display device;

FIG. 5 is a cross-sectional view showing the shape of a curved liquid crystal display panel;

FIG. 6 is a detailed cross-sectional view of a liquid crystal display panel;

FIG. 7 is a cross-sectional view showing a cross section taken near a columnar spacer of an ordinary liquid crystal display panel;

FIG. 8 is a cross-sectional view illustrating a problem with the ordinary liquid crystal display panel;

FIG. 9 is a cross-sectional view of a first embodiment of the present invention;

FIG. 10 is a cross-sectional view showing what happens when a liquid crystal display panel of the first embodiment is curved;

FIG. 11 is a perspective view of a cross spacer;

FIG. 12 is a plan view showing a pixel area on a TFT substrate in a second embodiment of the present invention;

FIG. 13 is a plan view showing a pixel area on a counter substrate in the second embodiment;

FIG. 14 is a plan view of a cross spacer;

FIG. 15 is a cross-sectional view of the cross spacer;

FIG. 16 is a cross-sectional view illustrating a problem with the cross spacer;

FIG. 17 is a plan view of a cross spacer in the second embodiment;

FIG. 18 is a cross-sectional view of the cross spacer in the second embodiment;

FIG. 19 is a cross-sectional view of a cross spacer in the second embodiment in effect when the liquid crystal display panel is curved;

FIG. 20 is a plan view of another type of cross spacer in the second embodiment;

FIG. 21 is a cross-sectional view of the other type of cross spacer in the second embodiment;

FIG. 22 is a cross-sectional view of the other type of cross spacer in the second embodiment in effect when the liquid crystal display panel is curved;

FIG. 23 is a cross-sectional view of a liquid crystal display panel as a third embodiment of the present invention;

FIG. 24 is an explanatory view of a liquid crystal display panel as a fourth embodiment of the present invention;

FIG. 25 is a cross-sectional view showing typical dimensions of a columnar spacer;

FIG. 26 is a schematic view showing an example in which columnar spacers are laid out in a peripheral region of the display area;

FIG. 27 is a schematic view showing an example in which columnar spacers are laid out in a central region of the display area in the fourth embodiment;

FIG. 28 is a schematic view showing another example in which column spacers are laid out in the central region of the display area in the fourth embodiment;

FIG. 29 is a cross-sectional view of a columnar spacer and an auxiliary columnar spacer;

FIG. 30 is a schematic view showing another example in which the screen of the liquid crystal display device is curved; and

FIG. 31 is a schematic view showing yet another example in which the screen of the liquid crystal display device is curved.

### DESCRIPTION OF THE PREFERRED EMBODIMENTS

The present invention is described below in detail using preferred embodiments.

### First Embodiment

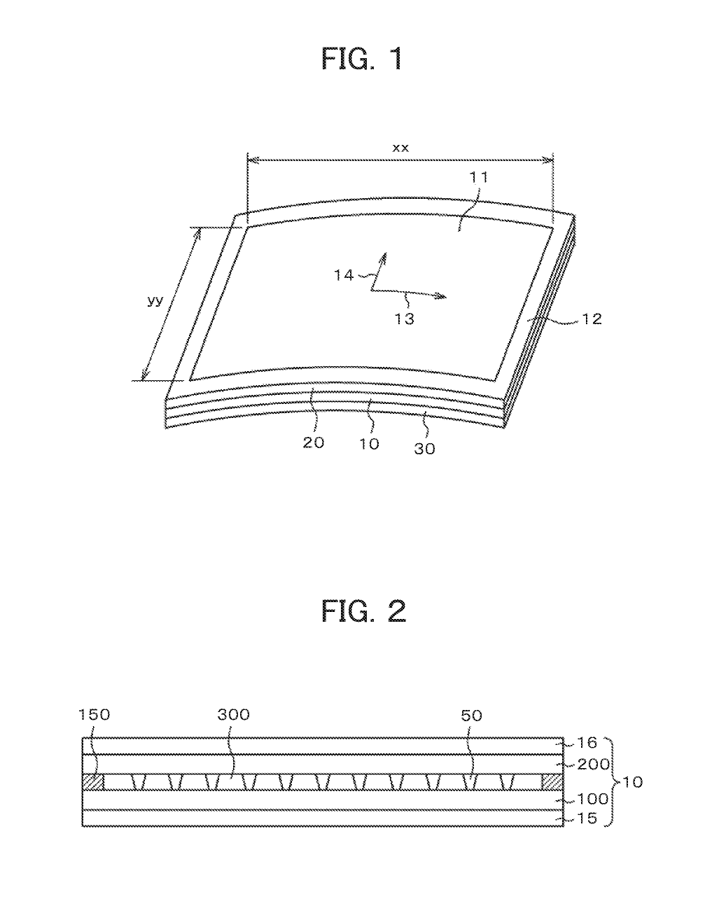

FIG. 1 is a perspective view of a curved liquid crystal display device. The display device in FIG. 1 is bent to have its convex screen facing the viewer. In FIG. 1, a protective panel 20 is disposed at the top, under which is a liquid crystal display panel 10. A backlight 30 is disposed at the back of the liquid crystal display panel 10. In FIG. 1, a frame area 12 is formed at the periphery of a rectangular display area 11. In FIG. 1, the long side dimension xx of the display area 11 is 230 mm, its short side dimension yy is 90 mm, and its radius of curvature is 500 mm, for example. FIG. 1 shows an example of a cylindrical curvature. This curvature has a curved axis 13 and an axis 14 perpendicular to the curved axis 13.

FIG. 2 is a cross-sectional view of a liquid crystal display panel. In FIG. 2, a counter substrate 200 is disposed opposite to a TFT substrate 100 having TFTs and pixel electrodes, among others, formed thereon in a matrix pattern. The TFT substrate 100 and the counter substrate 200 are bonded together by a peripherally placed sealant. Liquid crystal 300 is hermetically contained between the TFT substrate 100 and the counter substrate 200. The gap between the TFT substrate 100 and the counter substrate 200 is maintained by columnar spacers 50.

A lower polarizing plate 15 is pasted onto the underside of the TFT substrate 100. An upper polarizing plate 16 is pasted onto the upper side of the counter substrate 200. According to the present invention, as shown in FIG. 2, a flat liquid crystal display panel 10 is first formed and then bent into a curved shape when pasted onto a protective plate 20.

To bend the liquid crystal display panel 10 involves manufacturing a glass-formed TFT substrate 100 and counter substrate 200 measuring 0.2 mm or less in thickness, or 0.15 mm or less for more curvature. However, commercially available glass substrates are standardized to measure 0.7 mm or 0.5 mm in thickness, for example. In order to attain a substrate thickness of about 0.15 mm, the substrates from a completed mother substrate are ground to be thinned.

The lower polarizing plate 15 pasted onto the underside of the TFT substrate 100 and the upper polarizing plate 16 pasted onto the upper side of the counter substrate 200 are each made of plastic and about 0.1 mm in thickness. That means the bending stress of the polarizing plates is very small.

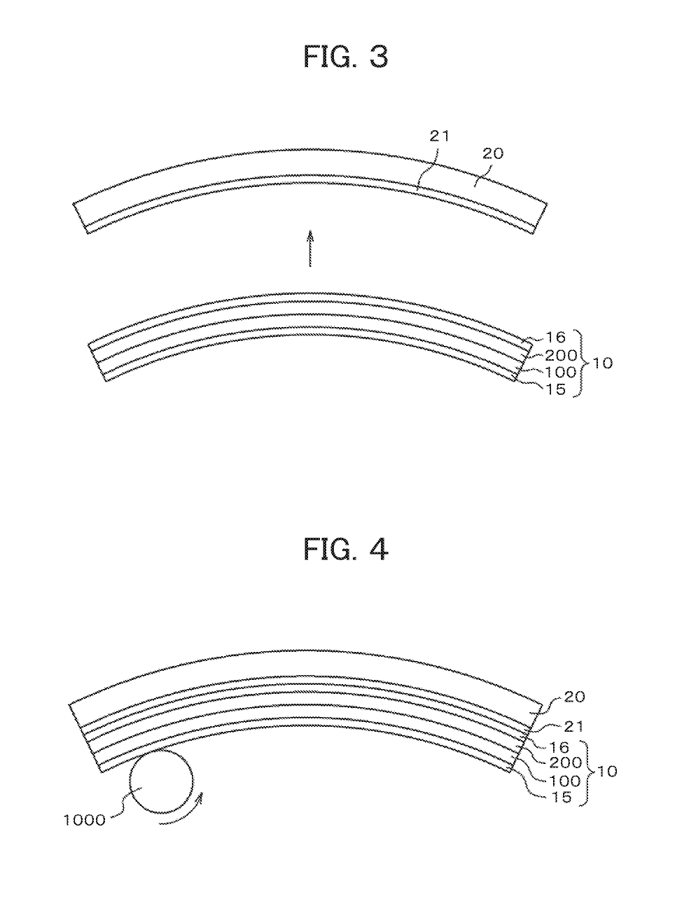

FIG. 3 is a cross-sectional view of a curved liquid crystal display panel halfway through the manufacturing process. In FIG. 3, the protective plate 20 is shown already formed over the curvature. An adhesive 21 is applied to the inner surface side of the protective plate 20. In FIG. 3, the liquid crystal display panel 10 is ground to the thickness of about 0.15 mm as discussed above in reference to FIG. 2. That means the liquid crystal display panel 10 is easy to bend. The flat liquid crystal display panel 10 is initially disposed along the inner surface of the protective plate 20, as indicated by an arrow. This causes the liquid crystal display panel 10 to bend into a curved shape. The liquid crystal display panel 10 in FIG. 3 is defined to be curved toward the TFT substrate 100.

FIG. 4 is a cross-sectional view showing a process for disposing the liquid crystal display panel 10 along that inner surface of the protective plate 20 which is provided with the adhesive 21. In FIG. 4, the protective plate 20 has a thickness of at least 0.5 mm and is more rigid than the liquid crystal display panel 10. Thus the liquid crystal display panel 10 is curved in conformity with the curved surface of the protective plate 20.

The protective plate 20 and the liquid crystal display panel 10 are bonded together by the adhesive 21. A roller 1000 is rolled over the liquid crystal display panel. 10 to bond it to the protective plate 20 with enhanced adhesive force. The protective plate 20 may be formed of glass or of plastic. The protective plate 20 can be bent by heat or by press bending, for example.

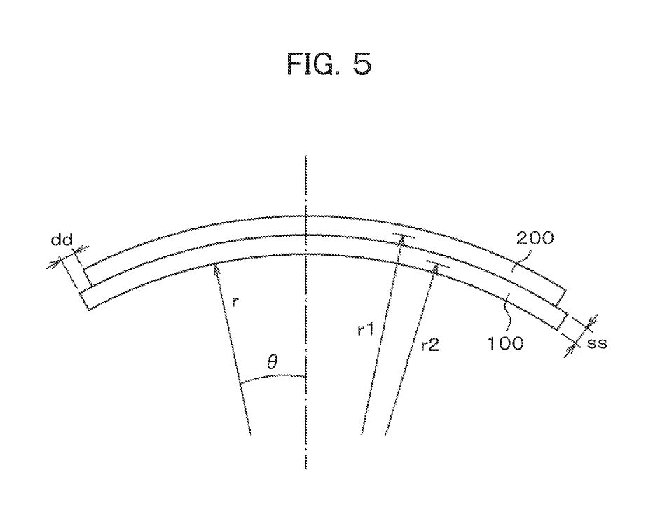

FIG. 5 is a cross-sectional view showing how the liquid crystal display panel 10 is stressed or distorted when bent into a curved shape. FIG. 5 shows only the TFT substrate 100 and the counter substrate 200 of the liquid crystal display panel 10. With the liquid crystal display panel 10 bent to have its convex screen facing the viewer as shown in FIG. 5, it is assumed that the TFT substrate 100 and the counter substrate 200 are both curved to the same angle θ. In this case, the difference in the radius of curvature between the TFT substrate 100 and the counter substrate 200 generates stress in the TFT substrate 100, causing the TFT substrate 100 to extend outwardly relative to the counter substrate 200.

If r1 is assumed to denote the radius of curvature of the counter substrate 200 and r2 is assumed to represent the radius of curvature of the TFT substrate 100, the amount of displacement between the two substrates at the angle θ in a curved axis direction thereof is defined as (r1−r2) θ, where θ is in radians. If the long side dimension of the display area 11 is 230 mm and the radius of curvature on the surface of the counter substrate 200 is 500 mm, that means sin⁻¹=(115/500) so that the angle θ is 13.297 degrees, or 0.232 radians at the edge of the display area in the curved axis direction thereof. Since r1−r2=ss may be considered to be the thickness of the counter substrate 200, the substrate thickness of 0.15 mm translates into a displacement dd of 0.035 mm (=0.15×0.232) between the TFT substrate 100 and the counter substrate 200 at the edge of the liquid crystal display panel 10 in FIG. 5 in the curved axis direction thereof. The value 0.035 mm equals 35 μm, which is a significantly large value for the liquid crystal display device.

In practice, the sealant 150 or like substance restrains the substrate movement, so that the displacement does not quite become as large as 35 μm but still is not negligible. The deformation stemming from bending the liquid, crystal display panel 10 into a curved shape can cause various problems as described above. One such problem is related to the columnar spacers 50 that determine the gap between the TFT substrate 100 and the counter substrate 200.

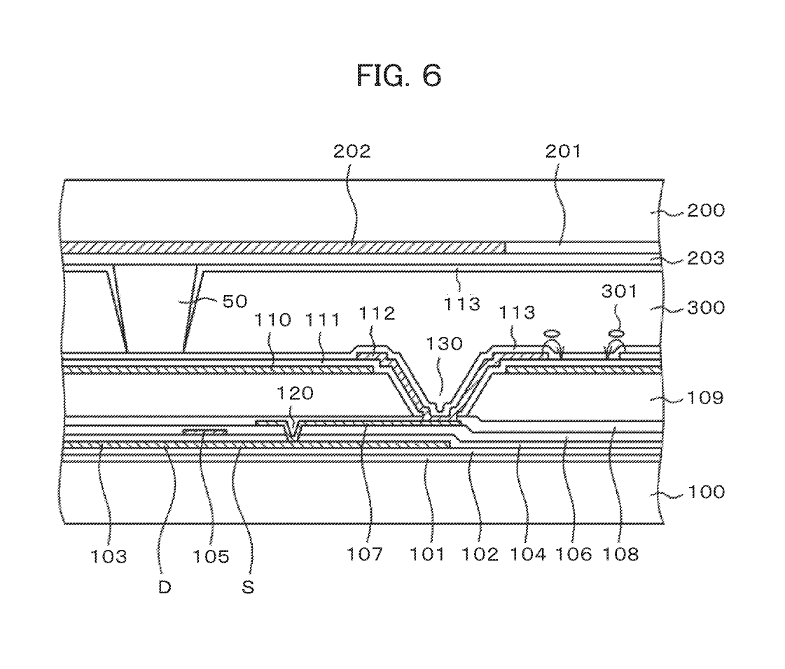

FIG. 6 is a cross-sectional view of the display area of an in-plane switching (IPS) liquid crystal display device. The TFT shown in FIG. 6 is a so-called top gate type TFT made of a low temperature polysilicon (LTPS) semiconductor. Where an amorphous silicon (a-Si) semiconductor is used, the so-cailed bottom gate TFTs are often formed.

In FIG. 6, a first base film 101 made of silicon nitride (SiN) and a second base film 102 made of silicon dioxide (SiO₂) are formed over the glass substrate 100 by chemical vapor disposition (CVD). The first base film 101 and the second base film 102 play the role of protecting a semiconductor layer 103 from contamination by impurities from the glass substrate 100.

The semiconductor layer 103 is formed on the second base film 102. The semiconductor layer 103 is formed by first having an amorphous silicon (a-Si) film formed by CVD over the second base film 102 and by having the deposited a-Si film annealed by laser for transformation into a polysilicon film. The polysilicon film is patterned by photolithography.

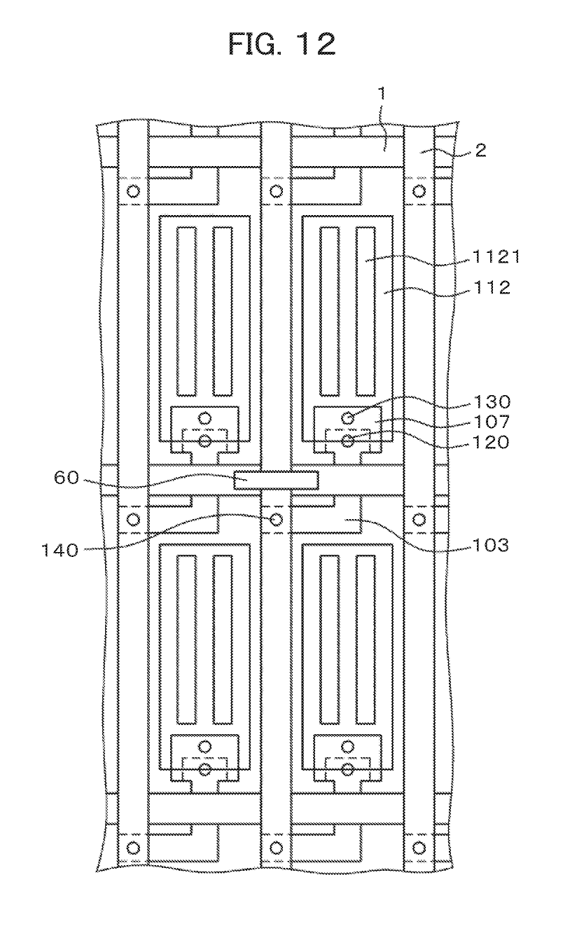

A gate insulating film 104 is formed on the semiconductor film 103. The gate insulating film 104 is an SiO₂ film made of tetraethoxysilane (TEOS). This film, too, is deposited by CVD. Gate electrodes 105 are formed on the gate insulating film 104. Scanning lines 1 shown in FIG. 12 double as the gate electrodes 105. The gate electrodes 105 are typically formed by a molybdenum tungsten (Mow) film. If it is necessary to reduce the resistance of the gate electrodes 105 or of the scanning lines 1, an aluminum (Al) alloy is used. In the semiconductor layer 103, a TFT drain D and a TFT source S are formed in a manner sandwiching each gate electrode 105.

Thereafter, a first interlayer insulating film 106 is formed by SiO₂ to cover the gate electrodes 105. The first interlayer insulating film 106 provides insulation between the gate electrodes 105 and contact electrodes 107. In the first interlayer insulating film 106 and the gate insulating film 104, through holes 120 are formed to connect the sources S of the semiconductor layer 103 to the contact electrodes 107. The through holes 120 are formed by lithography simultaneously in the first interlayer insulating film 106 and the gate insulating film 104.

The contact electrodes 107 are formed on the first interlayer insulating film 106. The contact electrodes 107 are connected to pixel electrodes 112 via through holes 130. The drains D of the TFTs are connected to video signal lines 2 shown in FIG. 12 via through holes 140.

The contact electrodes 107 and the video signal lines 2 are formed simultaneously in the same layer. The contact electrodes 107 and the video signal lines (represented by the contact electrodes 107 hereunder) may be formed by an aluminum silicon (AlSi) alloy, for example, to lower their resistance. Because AlSi alloys tend to cause hillock formation or trigger aluminum diffusion into other layers, the AlSi layer is typically configured to be sandwiched between an MoW-formed barrier layer and a cap layer.

An inorganic passivation film (insulating film) 108 is formed to cover the contact electrodes 107, thereby protecting the TFTs as a whole. As with the first base film 101 and other films, the inorganic passivation film 108 is formed by CVD. The inorganic passivation film 108 may not be formed depending on the product type. An organic passivation film 109 is formed to cover the inorganic passivation film 108. The organic passivation film 109 is made of a photosensitive acrylic resin. The organic passivation film 109 may also be made of silicone resin, epoxy resin, or polyimide resin besides the acrylic resin. The organic passivation film 109 is formed to be sufficiently thick because it functions as a planarizing film. The organic passivation film 109 is about 1 to 4 μm in thickness, and most often about 2 μm thick.

In order to provide conductivity between the pixel electrodes 112 and the contact electrodes 107, the through holes 130 are formed in the inorganic passivation film 108 and organic passivation film 109. The organic passivation film 109 is made of a photosensitive plastic resin. The photosensitive plastic resin, after being applied, is exposed to light. The exposure causes only those portions of the resin which have been exposed to light to dissolve in a specific developing solution. That is, the use of a photosensitive plastic resin makes it possible to bypass photo resist formation. After the through holes 130 have been formed in the organic passivation film 109, the organic passivation film 109 is burned to completion at about 230 degrees Celsius.

After that, an indium tin oxide (ITO) film that will later constitute a common electrode 110 is formed by sputtering. The ITO film is then patterned so that it is removed from the through holes 130 and their vicinities. The common electrode 110 may be formed flat for all pixels. Then a silicon nitride (SiN) film that will constitute a second interlayer insulating film 111 is deposited all over the substrate by CVD. Thereafter, the through holes 130 for providing conductivity between the contact electrodes 107 and the pixel electrodes 112 are formed in the second interlayer insulating film 111 and in the inorganic passivation film 108.

Another ITO film is then formed by sputtering and is patterned to form the pixel electrodes 112. FIG. 12 shows typical flat-shaped pixel electrodes 112 according to the present invention. An oriented film material is applied onto the pixel electrodes 112 by flexographic printing or by ink jet printing. The oriented film material thus applied is burned to form an oriented film 113. The orientation processing of the oriented film 113 has recourse to the rubbing method as well as photo-orientation involving polarized ultraviolet light.

Impressing a voltage between the pixel electrodes 112 and the common electrode 110 generates electric lines of force as shown in FIG. 6. This electric field causes liquid crystal molecules 301 to rotate, controlling the amount of light passing through the liquid crystal layer 300 per pixel to form an image.

In FIG. 6, the counter substrate 200 is shown disposed to contain the liquid crystal layer 300. Color filters 201 are disposed on the inner side of the counter substrate 200. The color filters 201 are constituted per pixel by a red color filter, a green color filter, and a blue color filter, which combine to form a color image. A black matrix 202 interposed between the color filters 201 serves to enhance the contrast of the image.

An overcoat film 203 is formed to cover the color filters 201 and the black matrix 202 that is a kind of light shielding film. The irregular surfaces of the color filters 201 and the black matrix 202 are planarized by the overcoat film 203.

The columnar spacers 50 are formed on the overcoat film. 203 to determine the gap between the TFT substrate 100 and the counter substrate 200. Also formed on the overcoat film 203 is the oriented film 113 for determining the initial orientation of the liquid crystal. Because the columnar spacers 50 stand higher than the other portions, the oriented film 113 is either not formed on the columnar spacer 50 by the leveling effect, or formed but is thinner than the other portions. As with the oriented film 113 on the TFT substrate 100, the orientation processing of the oriented film 113 on the counter substrate 200 has recourse to the rubbing method as well as photo-orientation involving polarized ultraviolet light.

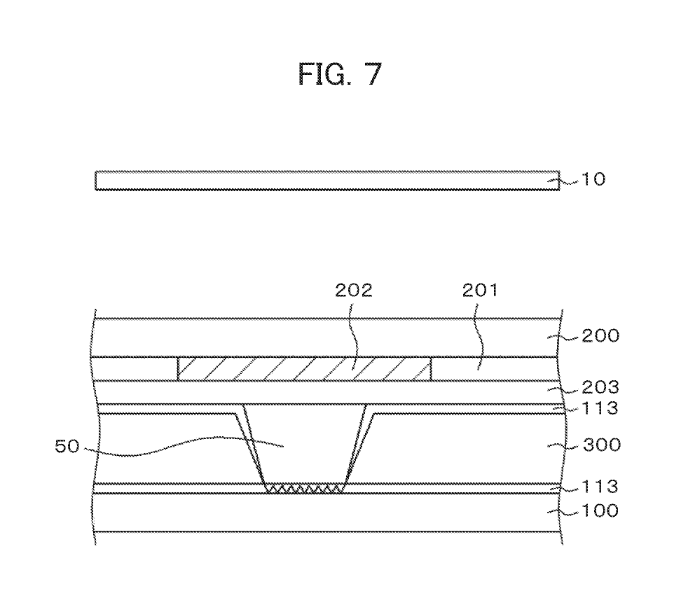

The columnar spacers 50 that determine the gap between the TFT substrate 100 and the counter substrate 200 are in contact with the oriented film 113 on the TFT substrate 100. The oriented film 113, which is about 100 nm thick, is ground when coming into contact with the columnar spacers 50. FIG. 7 is a schematic cross-sectional view showing how the grinding takes place. The upper part in FIG. 7 shows the liquid crystal display panel 10 as it is left flat.

In FIG. 7, a columnar spacer 50 is shown formed on the overcoat film 203 on the side of the counter substrate 200. The columnar spacer 50 is in contact with the oriented film. 113 on the TFT substrate 100. In FIG. 7, all portions except for the oriented film 113 are omitted on the TFT substrate 100.

The portions of the columnar spacers 50 cause light leakage by disturbing the orientation of the liquid crystal 300. To deal with this problem, the black matrix 202 is formed over those portions of the counter substrate 200 which correspond to the columnar spacers 50. These portions are thus not visible from the outside even when the oriented film 113 is ground on the TFT substrate 100.

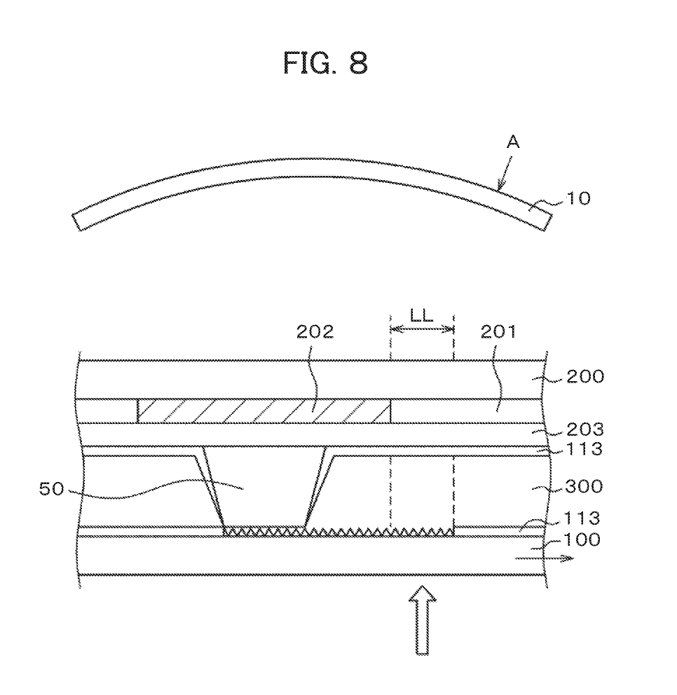

FIG. 8 shows an example in which the liquid crystal display panel 10 is bent into a curved shape. The upper part of FIG. 8 shows a curved liquid crystal display panel 10. When bent into a curved shape, the liquid crystal display panel 10 produces a displacement between the TFT substrate 100 and the counter substrate 200, as explained above in reference to FIG. 5. That is, the panel is distorted so that the TFT substrate 100 is displaced outwardly relative to the counter substrate 200. The lower part of FIG. 8 is a detailed cross-sectional view taken of position A on the liquid crystal display panel 10 shown in the upper part.

When the TFT substrate 100 is displaced outwardly relative to the counter substrate 200, the oriented film 113 on the TFT substrate 100 is ground thereby. The ground portion of the oriented film 113 is indicated as fine asperities in FIG. 8. The ground portion causes the oriented film 113 to lose its orienting effect, resulting in light leakage from the backlight.

As shown in FIG. 8, bending the liquid crystal display panel 10 into a curved shape displaces the TFT substrate 100 outwardly relative to the counter substrate 200 and thereby grinds oriented film portions. The ground oriented film portions are not covered by the black matrix 202 and lead to light leakage from the backlight as indicated by a hollow arrow. In FIG. 8, a range LL is where light leakage takes place. The light leakage, if incurred, degrades the contrast of the image.

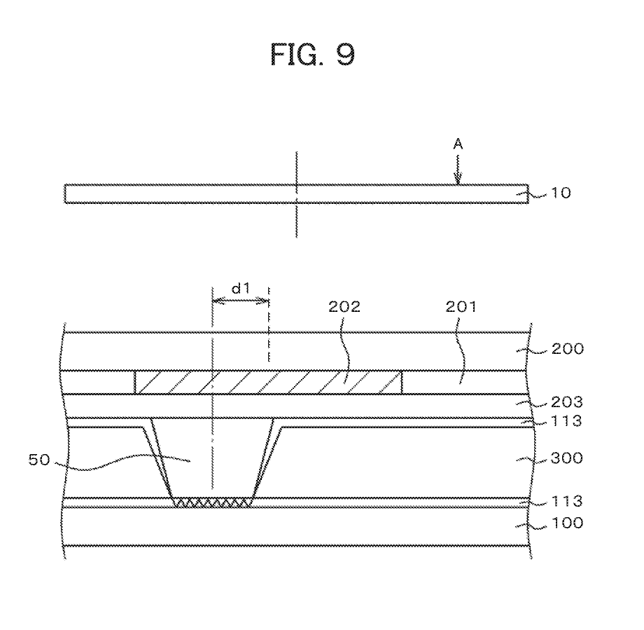

FIG. 9 is a schematic cross-sectional view of a liquid crystal display panel to which the present invention is adapted. The upper part of FIG. 9 shows the liquid crystal display panel 10 as it is left flat. The lower part of FIG. 9 is a detailed cross-sectional view taken of position A of the liquid crystal display panel 10. The cross-sectional structure in FIG. 9 is basically the same as in FIG. 7. What characterizes the structure in FIG. 9 is that in the curved axis direction, the center of the columnar spacer 50 is displaced from the center of the black matrix 202 to the center of the screen.

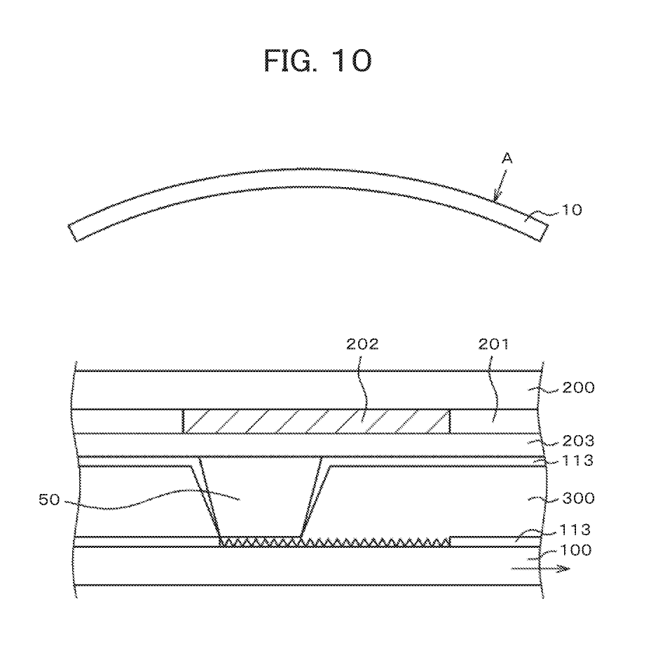

FIG. 10 is a schematic view showing the case in which the liquid crystal display panel 10 shown in FIG. 9 is bento into a curved shape. The upper part of FIG. 10 shows a curved liquid crystal display panel 10. The lower part of FIG. 10 is a detailed cross-sectional view taken of position A on the liquid crystal display panel 10 shown in the upper part. FIG. 10 shows a state in which bending the liquid crystal display panel 10 into a curved shape has caused the TFT substrate 100 to shift outwardly from the center of the screen relative to the counter substrate 200. In FIG. 10, the center of the columnar spacer 50 is originally displaced toward the center of the display area relative to the center of the black matrix 202. For this reason, even when the TFT substrate 100 is displaced outwardly, the ground oriented film portions on the TFT substrate 100 are still covered by the black matrix 202 on the counter substrate 200. The ground oriented film thus does not trigger light leakage.

### Second Embodiment

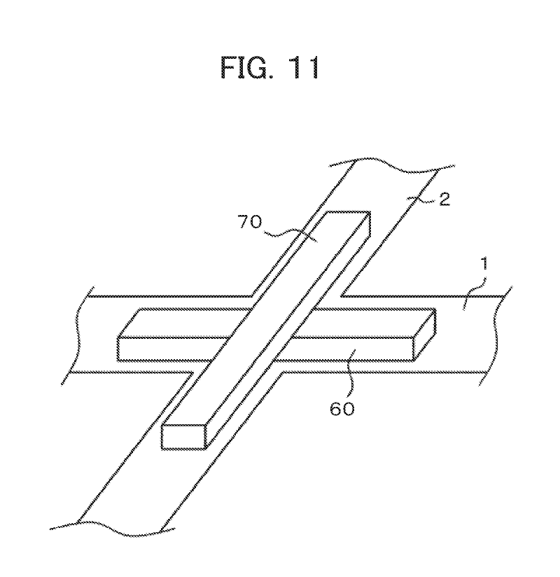

FIG. 11 is a perspective view of a so-called cross spacer configured to determine the gap between the TFT substrate and the counter substrate in the second embodiment of the present invention. As shown in FIG. 11, the gap between the TFT substrate and the counter substrate is determined by a lower bar spacer 60 and an upper bar spacer 70 arranged to make up a cross shape, the lower bar spacer 60 having its long side dimension oriented in the crosswise direction of the TFT substrate, the upper bar spacer 70 having its long side dimension oriented in the longitudinal direction of the counter substrate. The lower bar spacer 60 and the upper bar spacer 70 are collectively called the cross spacer. In FIG. 11, the lower bar spacer 60 is disposed on a scanning line 1, and the upper bar spacer 70 is disposed in a position corresponding to a video signal line 2. Thus many cross spacers are disposed at the intersections between the scanning lines 1 and the video signal lines 2. Contrary to what is shown in FIG. 11, the lower bar spacer 60 may have its long side dimension oriented in the longitudinal direction and the upper bar spacer 70 may have its long side dimension oriented in the crosswise direction.

FIG. 12 is a plan view of a pixel area on the TFT substrate 100 where a lower bar spacer 60 is disposed. Each pixel is located in a region enclosed by the scanning lines 1 extending in the crosswise direction and the video signal lines 2 extending in the longitudinal direction. The center between adjacent video signal lines 2 constitutes the center of each pixel in its horizontal direction, and the center between adjacent scanning lines 1 makes up the center of each pixel in its vertical direction. In FIG. 12, the lower bar spacer 60 is shown disposed on a scanning line 1 at the point of intersection between that scanning line 1 and a video signal line 2, the long side dimension of the lower bar spacer 60 being positioned in the crosswise direction.

Each pixel has a pixel electrode 112 having slits 1121. The video signal lines 2 and the pixel electrodes 112 are interconnected via the semiconductor layer 103 and the contact electrodes 107. With the semiconductor layer 103 passed under the scanning lines 1, the scanning lines 1 play the role of gate electrodes formed of TFTs. Whereas FIG. 11 shows a single gate structure, a double gate structure may be devised if the semiconductor layer 103 is passed twice under the scanning lines 1.

The video signal lines 2 and the semiconductor layer 103 are interconnected via the through holes 140. The semiconductor layer 103 and the contact electrodes 107 are interconnected via the through holes 120. The contact electrodes 107 and the pixel electrodes 112 are interconnected via the through holes 130. An interlayer insulating film is disposed under the pixel electrodes 112. A flat-shaped common electrode is disposed under the interlayer insulating film.

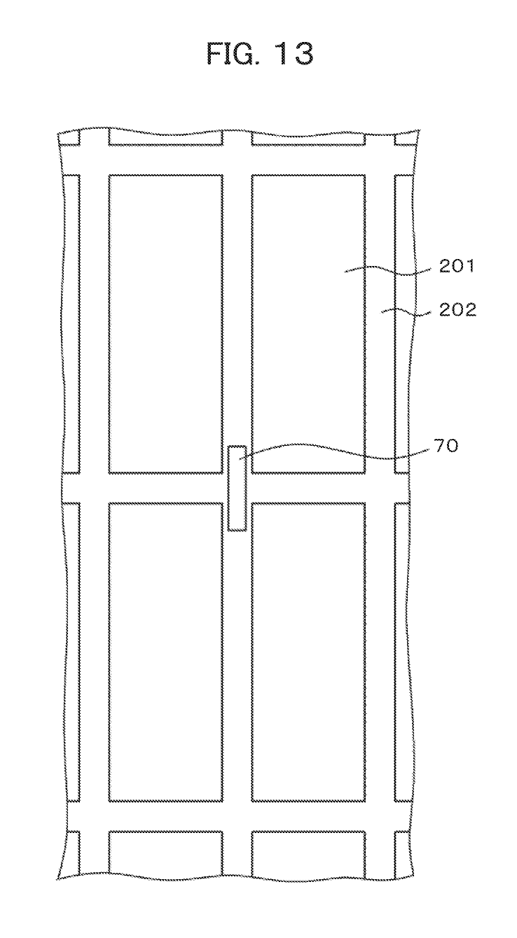

FIG. 13 is a plan view of an upper bar spacer 70 disposed on the counter substrate 200. In FIG. 13, the rows and columns of the black matrix 202 extend in the longitudinal and crosswise directions in FIG. 13, an upper bar spacer 70 with its long side dimension in the longitudinal direction is formed at a point of intersection between a row and a column of the black matrix 202. The rows of the black matrix 202 extending in the crosswise direction are formed in positions corresponding to the scanning lines 1 on the TFT substrate 100. The columns of the black matrix 202 extending in the longitudinal direction are formed in positions corresponding to the video signal lines 2 on the TFT substrate 100.

The color filters 201 are formed between the rows and columns of the black matrix 202. The center of each pixel in the horizontal direction on the counter substrate 200 may be said to be the center between adjacent columns of the black matrix 202 extending in the longitudinal direction. Also, the center of each pixel in the vertical direction on the counter substrate 200 may be said to be the center between adjacent rows of the black matrix 202 extending in the crosswise direction. If there is no black matrix 202, the center of each pixel is defined to be the center of the color filters 201.

FIG. 14 is a plan view of a cross spacer as viewed from the counter substrate 200. The cross spacer is disposed at the point of intersection between a row of the black matrix 202 extending in the crosswise direction and a column of the black matrix 202 extending in the longitudinal direction. The upper bar spacer 70 and the lower bar spacer 60 are designed to cross at their center point.

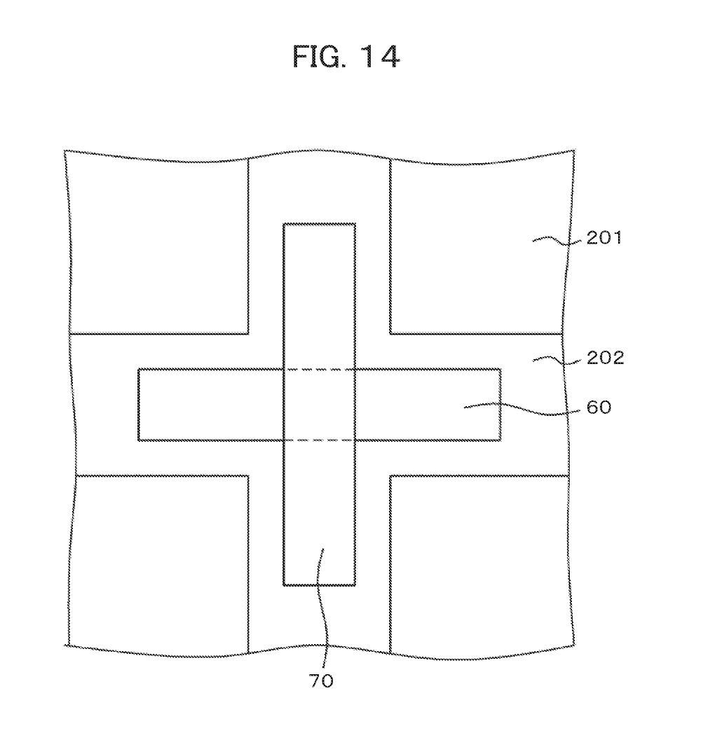

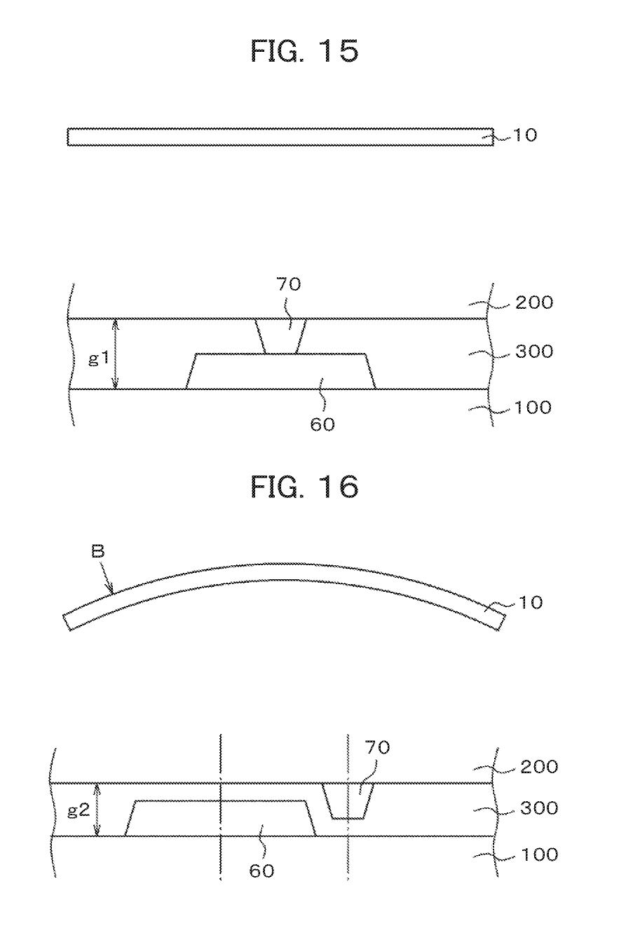

FIG. 15 is a cross-sectional view of the state in FIG. 14 where the liquid crystal display panel 10 is flat. The upper part of FIG. 15 shows the liquid crystal display panel 10 as it is left flat. In FIG. 15, a gap q1 between the TFT substrate 100 and the counter substrate 200 is determined by the upper bar spacer 70 and the lower bar spacer 60 contacting each other to form a cross.

FIG. 16 is across-sectional view showing a cross section of the liquid crystal display panel 10 in FIG. 15 as it is bent into a curved shape. The upper part of FIG. 16 shows a curved liquid crystal display panel 10. The lower part of FIG. 16 is a cross-sectional view taken of position B, for example, on the liquid crystal display panel 10 shown in the upper part. FIG. 16 shows that bending the liquid crystal display panel 10 into a curved shape has displaced the TFT substrate 100 outwardly, causing the upper bar spacer 70 to fall off the lower bar spacer 60. This has reduced the initial gap g1 to a gap g2 between the TFT substrate 100 and the counter substrate 200. Such gap variations can trigger brightness and color irregularities on the screen.

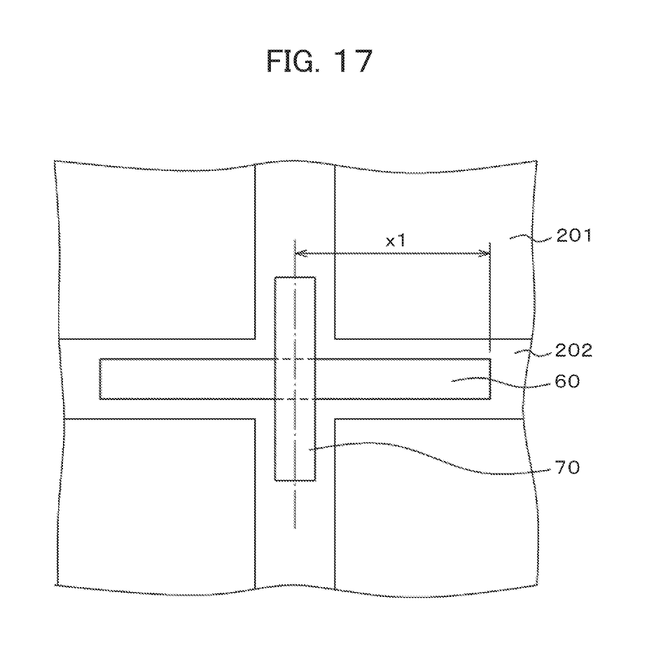

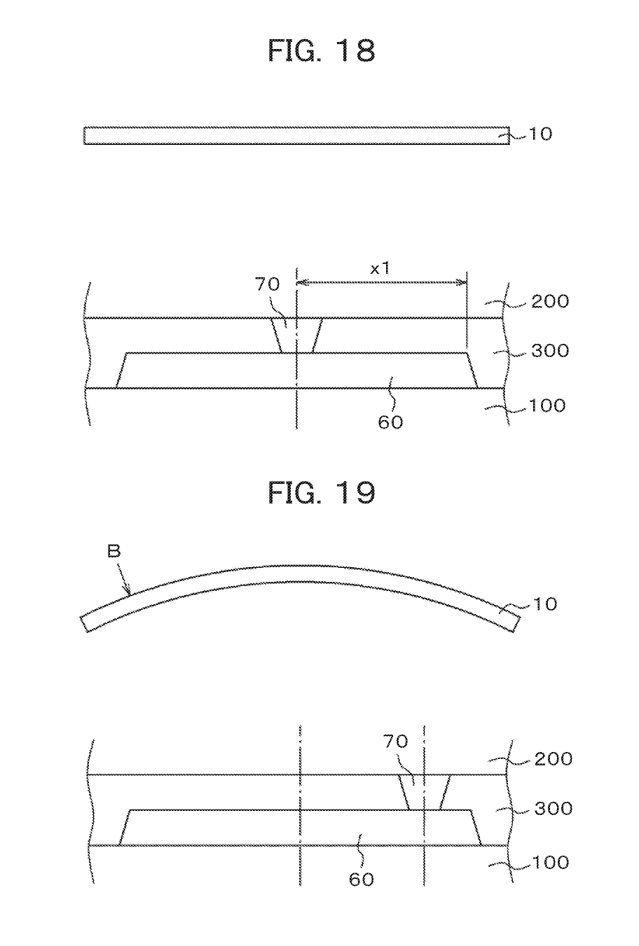

FIG. 17 is a plan view of a cross spacer as viewed from the counter substrate side in this embodiment. What makes the cross spacer in FIG. 17 different from that in FIG. 14 is that the lower bar spacer 60 is longer than the upper bar spacer 70. FIG. 18 is a cross-sectional view of the cross spacer in FIG. 17. The upper part of FIG. 18 shows the liquid crystal display panel 10 as it is left flat. In FIG. 18, the lower bar spacer 60 is shown longer than that in FIG. 15.

FIG. 19 is a cross-sectional view of a liquid crystal display panel bent into a curved shape. The upper part of FIG. 19 shows a curved liquid crystal display panel 10. The lower part of FIG. 19 shows a state in which bending the liquid crystal display panel 10 into a curved shape has displaced the TFT substrate 100 outwardly relative to the counter substrate 200 at point B shown in the upper-part subfigure, i.e., shifted the TFT substrate 100 leftward. In FIG. 19, however, the lower bar spacer 60 is formed to be longer, so that the upper bar spacer 70 does not fall off the lower bar spacer 60. This keeps the gap unchanged between the TFT substrate 100 and the counter substrate 200, with no brightness or color irregularities taking place on the screen.

In FIGS. 17 and 18, reference character x1 denotes the distance from the center of the short side dimension of the upper bar spacer 70 to the edge of the long side dimension of the lower bar spacer 60. The distance x1 needs to be long enough for the upper bar spacer 70 not to fall off the lower bar spacer 60 at the display area edge of the liquid crystal display panel. If the bar spacer 60 has a tapered side wall, the length of the bar spacer 60 is defined as the length of its upper surface. The lower bar spacers 60 may be formed to be gradually longer in their long side dimension direction as they are arranged from the center of the display area toward its edges.

FIGS. 17 to 19 show the case where the lower bar spacers 60 are formed on the TFT substrate 100 with their long side dimensions oriented in the crosswise direction. The same arrangements apply where the upper bar spacers 70 are formed on the counter substrate 200 with their long side dimensions oriented in the crosswise direction. That is, the bar spacers formed in parallel with the curved axis need only be made longer than the bar spacers with their long side dimensions oriented in a direction perpendicular to the curved axis.

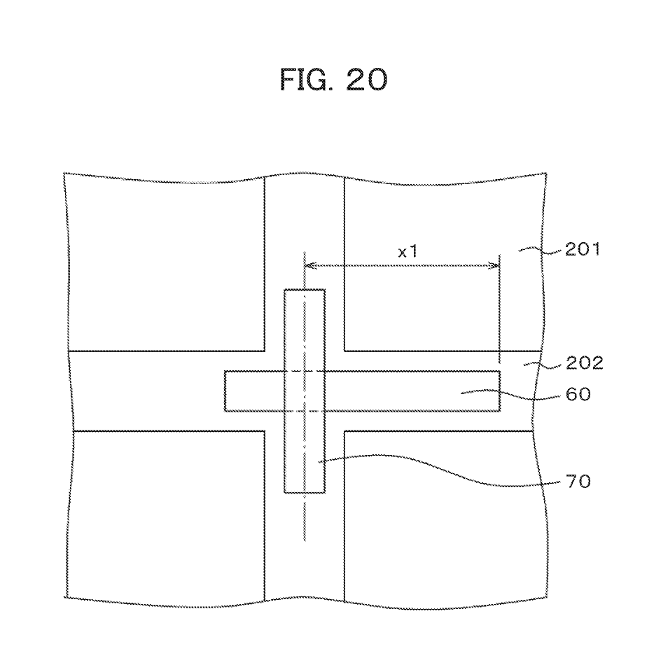

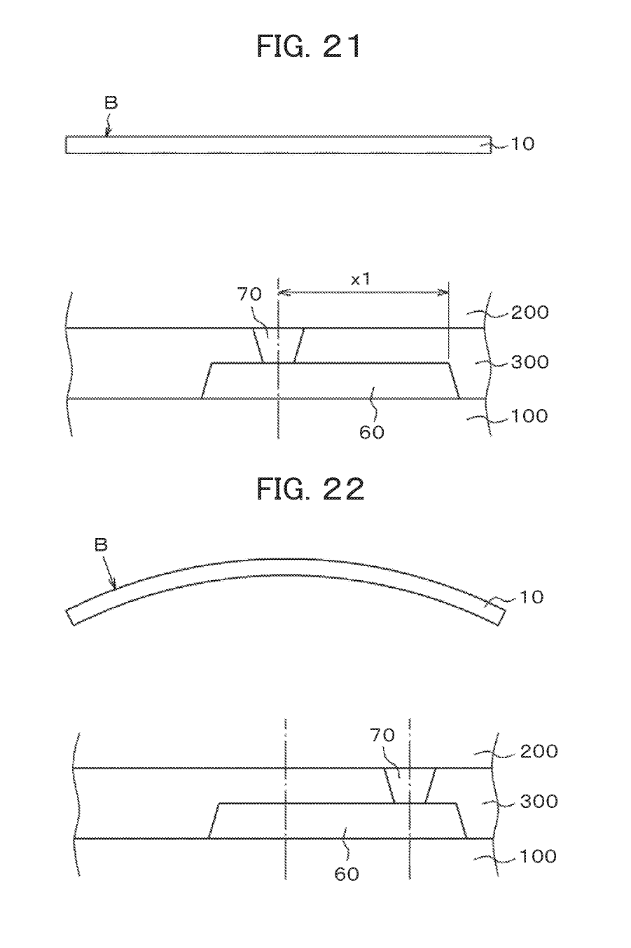

FIG. 20 is a plan view shows relations between the upper bar spacer 70 and the lower bar spacer 60 where the direction in which the screen is curved is predetermined. FIG. 20 illustrates the shape of a cross spacer at point B shown in the upper-part subfigure in FIG. 21. FIG. 20 is a plan view of a flat liquid crystal display panel formed on the assumption that the TFT substrate 100 will be displaced outwardly relative to the counter substrate 200 when the screen is bend into a curved shape. FIG. 21 shows cross sections taken of the structure in FIG. 20. The upper part of FIG. 21 shows the liquid crystal display panel 10 as it is left flat. The lower part of FIG. 21 is a cross-sectional view showing relations between the upper bar spacer 70 and the lower bar spacer 60. The center of the short side dimension of the upper bar spacer 70 is shown displaced leftward from the center of the long side dimension of the lower bar spacer 60.

FIG. 22 is a cross-sectional view showing the case where the liquid crystal display panel 10 depicted in FIG. 21 is bent into a curved shape. The upper part of FIG. 22 shows the liquid crystal display panel 10 as it is bent into a curved shape. The lower part of FIG. 22 is a cross section taken at point B, for example, in the upper-part subfigure, showing that the TFT substrate 100 is displaced outwardly relative to the counter substrate 200, i.e., shifted leftward. However, in FIG. 22, the upper bar spacer 70 is shown displaced in the long side dimension direction of the lower bar spacer 60, which prevents the upper bar spacer 70 from falling off the lower bar spacer 60. This keeps the gap unchanged between the TFT substrate 100 and the counter substrate 200, with no brightness or color irregularities taking place on the screen.

The distance x1, which ranges from the center of the short side dimension of the upper bar spacer 70 to the edge of the long side dimension of the lower bar spacer 60 in FIGS. 20 and 21, needs to be long enough for the upper bar spacer 70 not to fall off the lower her spacer 60 at the display area edge of the liquid crystal display panel 10 when the panel 10 is bent into a curved shape. The reason for that need is the same as discussed above in reference to FIGS. 17 and 18.

The case shown in FIGS. 20 and 21 applies to one direction away from the center of the display area along the curved axis, i.e., on the B side in FIG. 22. In the case of the opposite direction away from the display area center along the curved axis, the distance x1 is oriented in a direction opposite to what is shown in FIGS. 20 and 22. In the second embodiment, the bar spacers at the display area center are also arranged in a cross as shown in FIG. 14.

### Third Embodiment

As explained above in conjunction with the first and the second embodiments, the pixels formed on the TFT substrate 100 are displaced from the pixels formed on the counter substrate 200 when the liquid crystal display panel 10 is bent into a curved shape. If the center of each pixel on the TFT substrate 100 is made to coincide with the center of each pixel on the counter substrate 200 with the liquid crystal display panel 10 left flat, bending the liquid crystal display panel 10 into a curved shape displaces the pixel centers on the TFT substrate 100 from the pixel centers on the counter substrate 200, particularly at the periphery of the screen. The misalignment causes the light from the backlight having passed through the pixels on the TFT substrate 100 to pass not only through the intended color filter 201 but also through the adjacent color filter 201, bringing about a phenomenon called color mixture.

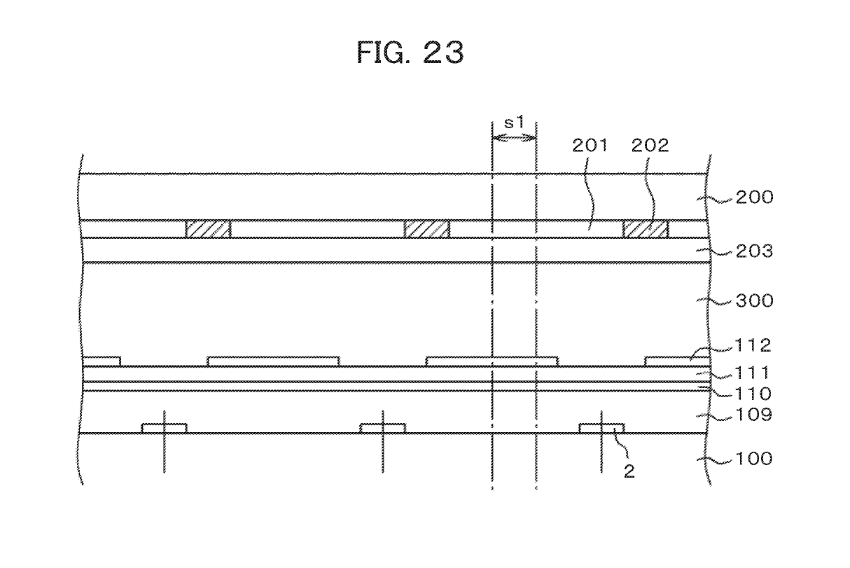

To prevent the problem of color mixture requires using a flat liquid crystal display panel and displacing beforehand the pixel centers on the TFT substrate 100 from the pixel centers on the counter substrate 200 in the curved axis direction, as shown in FIG. 23. In FIG. 23, the center of each pixel on the TFT substrate 100 is shown shifted left by a distance s1 from the center of each pixel on the counter substrate 200. The structure in FIG. 23 presuppose that when the liquid crystal display panel 10 is bent into a curved shape, the TFT substrate 100 is shifted right relative to the counter substrate 200.

The distance s1 shown in FIG. 23 varies depending on the location on the screen. That is, the distance s1 is zero at the center of the display area, and is maximized at the edge of the display area. The value of the distance s1 at the screen edge is determined by the screen size and by the curvature factor by which the screen is curved. The value of the distance s1 increases progressively from the center of the screen to the screen edge. The value of the distance s1 may be approximated using a quadratic function involving a value x representing the distance away from the display area center in the curved axis direction.

The center of each pixel on the TFT substrate 100 may be defined as the center between adjacent video signal lines 2. Where the columns of the black matrix 202 are formed along the video signal lines 2 on the TFT substrate 100, the center of each pixel electrode on the counter substrate 200 may be defined as the center between adjacent columns of the black matrix 202. If there is no such black matrix 202, the center of each pixel electrode on the counter substrate 200 may be defined as the center between the color filters 201 in the curved axis direction.

### Fourth Embodiment

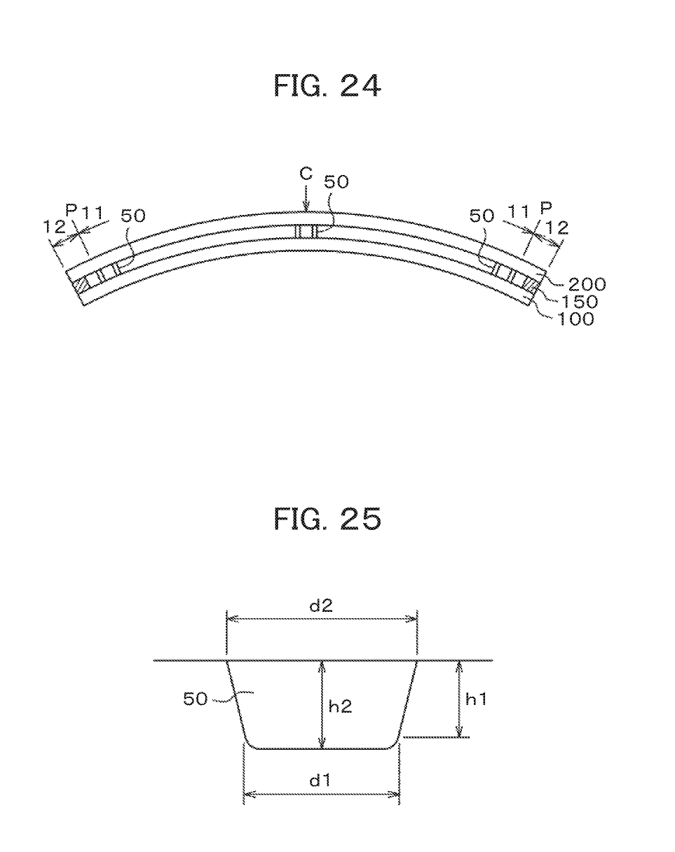

When the liquid crystal display panel 10 is bent into a curved shape, deformation occurs in the TFT substrate 100 and in the counter substrate 200. The amount of deformation is different between the TFT substrate 100 and the counter substrate 200. That means the stress on the columnar spacers 50 determining the gap between the TFT substrate 100 and the counter substrate 200 varies depending on the location over the liquid crystal display panel 10. FIG. 24 is a cross-sectional view, in the curved axis direction, of the liquid crystal display panel 10 as it is bent into a curved shape. Reference character C denotes the screen center, and reference character P represents the screen periphery. In FIG. 24, the gap between the TFT substrate 100 and the counter substrate 200 is shown determined by the columnar spacers 50. The TFT substrate 100 and the counter substrate 200 are bonded together at their peripheries by means of the sealant 150.

When the flatly formed liquid crystal display panel 10 is bent into a curved shape, the stress generated by bending works to narrow the gap between the TFT substrate 100 and the counter substrate 200. Generally, the stress is the largest near the center of the screen. If the same columnar spacers 50 are used, the gap between the TFT substrate 100 and the counter substrate 200 becomes narrower at the screen center than at the screen periphery. This can result in brightness irregularities, for example.

The fourth embodiment is intended to deal with that problem. FIG. 25 shows a typical columnar spacer 50 of which the cross section is trapezoidal. In FIG. 25, the height h2 of the columnar spacer 50 measures 2.9 μm, and the diameter d2 of the columnar spacer 50 at its root on the overcoat film side measures 14 μm. The diameter d1 of the columnar spacer 50 at its tip is defined at a height h1 that is 95% of the height h2 of the columnar spacer 50 (i.e., the diameter d1 is at the height h1 of 2.76 μm). It is thus assumed that when the columnar spacer 50 comes into contact with the TFT substrate 100, the columnar spacer 50 is slightly compressed to have the height h1.

The gap between the TFT substrate 100 and the counter substrate 200 is maintained by the repulsion force of the columnar spacers 50. The repulsion force of the columnar spacers 50 may be determined by their concentration or by their diameters. In other words, the repulsion force of the columnar spacers 50 is determined by the ratio of the contact area of the columnar spacers 50 on the TFT substrate 100. Where the liquid crystal display panel 10 is bent into a curved shape, the stress at the screen center increases. This requires making the ratio of the contact area of the columnar spacers 50 at the screen center higher than at the screen periphery.

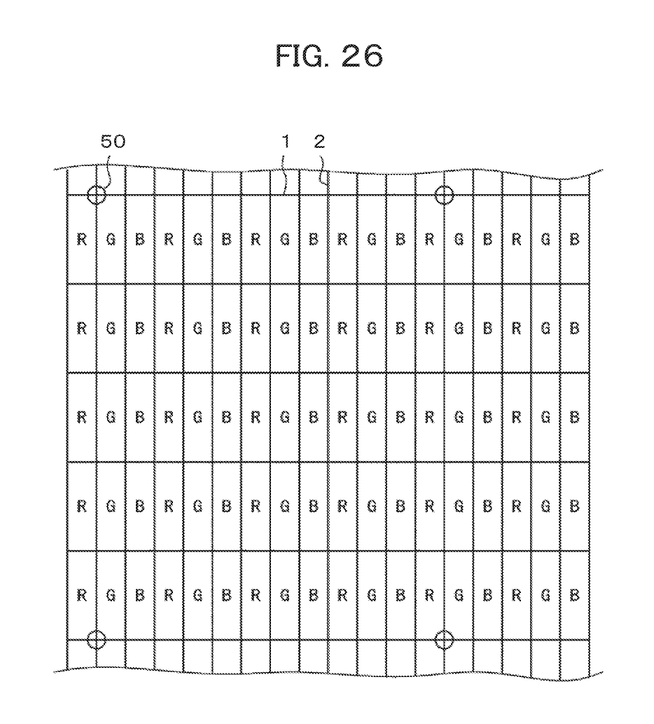

FIG. 26 is a plan view showing a typical distribution of columnar spacers at the screen periphery. In FIG. 26, reference characters R, G, and B denote red, green, and blue pixels, respectively. A columnar spacer 50 is disposed every 12 pixels in the crosswise direction and every 5 pixels in the longitudinal direction.

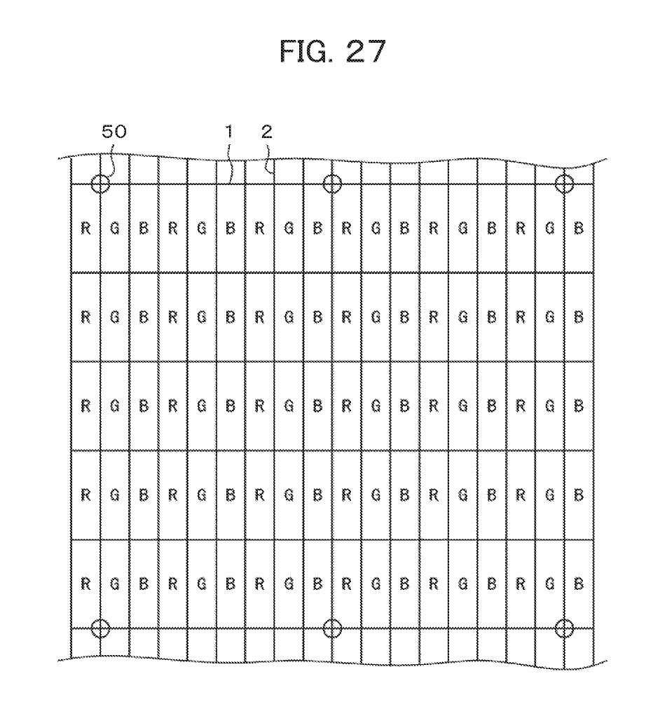

FIG. 27 shows an example in which the concentration of the columnar spacers 50 is changed so as to increase the ratio of the contact area of the columnar spacers 50 at the screen center. FIG. 27 is a plan view showing a typical distribution of the columnar spacers 50 in that case at the screen center. In FIG. 27, a columnar spacer 50 is shown disposed every 8 pixels in the crosswise direction and every 5 pixels in the longitudinal direction. That is, the ratio of the contact area of the columnar spacers 50 at the screen center is 50% higher than at the screen periphery shown in FIG. 26. The concentration of the columnar spacers 50 may be determined, for example, by measuring the ratio of those areas of the columnar spacers 50 which are in contact with the TFT substrate 100 per group of 300 pixels centering on the target location to be measured.

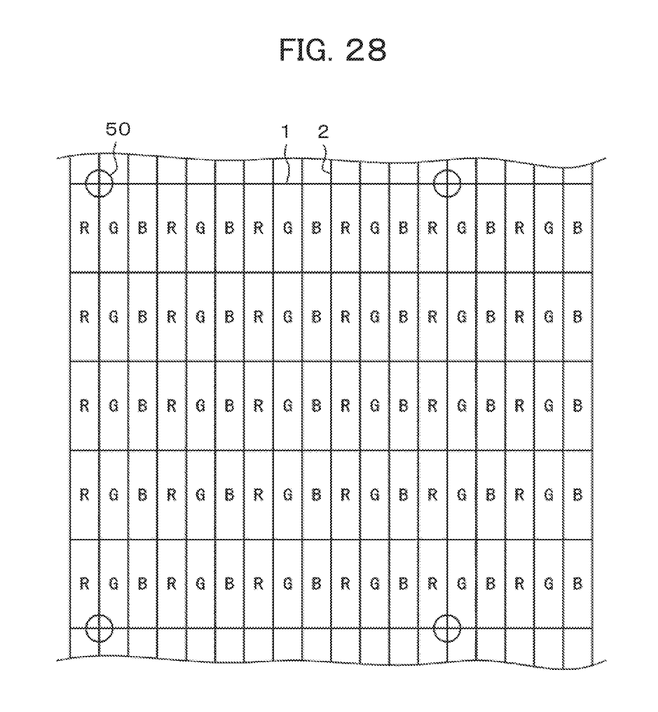

FIG. 28 shows an example in which the diameter of each of the columnar spacers 50 is changed to increase the ratio of their contact area at the screen center. FIG. 28 is a plan view showing a typical distribution of the columnar spacers 50 and their diameters at the screen center. In FIG. 28, a columnar spacer 50 is shown disposed every 12 pixels in the crosswise direction and every 5 pixels in the longitudinal direction. That is, the concentration of the columnar spacers 50 at the screen center is the same as at the screen periphery. However, the diameter of each of the columnar spacers 50 in FIG. 28 is larger than at the screen periphery. For example, if the diameter d1 of each of the columnar spacers 50 at the screen periphery in FIG. 26 is 8 μm and the diameter d2 of each of the columnar spacers 50 at the screen center is 12 μm, the ratio of the contact area of the columnar spacers 50 at the screen center is 2.25 times that of the columnar spacers 50 at the screen periphery.

Table 1 below shows a case where, with the concentration of the columnar spacers 50 kept constant, the diameter of each of the columnar spacers 50 is varied in order to change the ratio of their contact area. An optimal ratio of the contact area varies depending the degree of curvature of the screen. As shown in Table 1, a change in the diameter of a columnar spacer 50 as small as from 8 μm to 8.5 μm (i.e., a change of about 6%) is still effective for changing the contact area ratio.

TABLE 1

| | |
|---|---|
| Periphery | Center |

| | | Ratio of | | Ratio of |
|---|---|---|---|---|
| | Diameter | Contact | Diameter | Contact |
| Specs | d1 (in μm) | Area (%) | d1 (in μm) | Area (%) |
| 1 | 8.0 | 0.072 | 8.0 | 0.72 |
| 2 | 8.0 | 0.072 | 8.5 | 0.081 |
| 3 | 8.0 | 0.072 | 9.5 | 0.102 |
| 4 | 8.0 | 0.072 | 12.0 | 0.162 |

The ratio of the contact area of the columnar spacers need to be varied continuously from the screen center toward the screen periphery. Depending on the thickness and the radius of curvature of the TFT substrate or of the counter substrate in the liquid crystal display panel, the ratio of the contact area of the columnar spacers may be varied linearly or by a quadratic curve from the screen center toward the screen periphery.

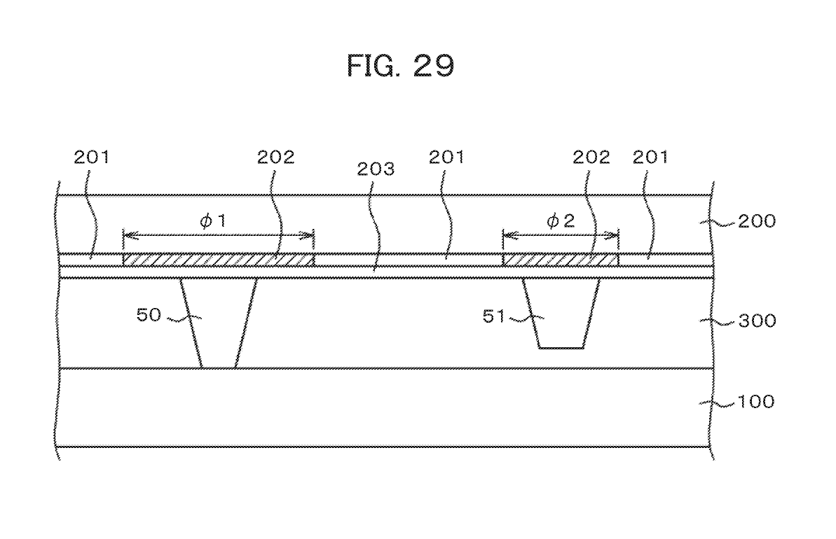

As shown in FIG. 29, two types of columnar spacers are provided: ordinary columnar spacers 50 that determine the gap between the TFT substrate 100 and the counter substrate 200 in the normal state; and auxiliary columnar spacers 51 which are normally not in contact with the TFT substrate 100 and which, when the counter substrate 200 is pressed by fingertips for example, come into contact with the TFT substrate 100 to ensure that the gap between the counter substrate 200 and the TFT substrate 100 is not reduced excessively. The ordinary columnar spacers 50 are subject to a larger amount of deformation caused by external stress, for example, than the auxiliary columnar spacers 51. For this reason, the diameter φ1 of the black matrix 202 corresponding to an ordinary columnar spacer 50 is larger than the diameter φ2 of the black matrix 202 corresponding to an auxiliary columnar spacer 51. The same applies to the cross spacers. The spacers discussed above in conjunction with the first, the second, and the fourth embodiments, for example, apply to the ordinary columnar spacers or the cross spacers that are normally in contact with the TFT substrate.

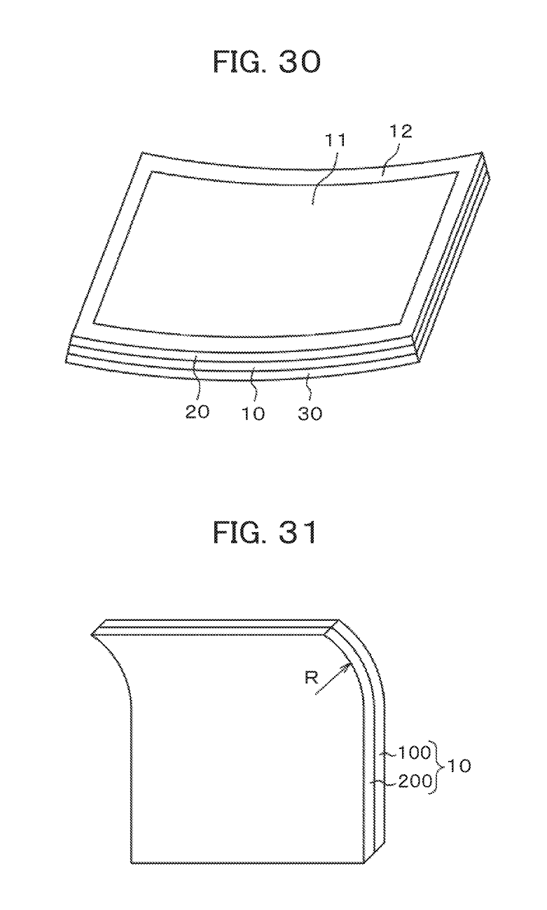

Regarding the first to the fourth embodiments, it was explained that the liquid crystal display panel is bent to have its convex screen facing the viewer, i.e., that the panel is curved toward the TFT substrate. However, this is not limitative of the present invention. Alternatively, the above explanations regarding the first to the fourth embodiments also apply if the liquid crystal display device or the liquid crystal display panel 10 is bent to have its concave screen facing the viewer, as shown in FIG. 30. In this case, however, the liquid crystal display panel 10 is bent toward the side of the counter substrate, generating deformation that displaces the counter substrate outwardly relative to the TFT substrate. It follows that the relations between the TFT substrate and the counter substrate need only be reversed as opposed to what was explained above in conjunction with the first to the third embodiments.

In another example, the liquid crystal display device may be disposed on the wall of an electric train. This type of liquid crystal display panel often takes on the shape shown in FIG. 31. That is, a region of the liquid crystal display panel is bent with a curvature factor that brings about a curve toward the counter substrate side, with the other panel regions left flat. In this case, except that the curve direction of the curved region is reversed, the arrangements discussed above in conjunction with the first to the fourth embodiments also apply.

The liquid crystal display device explained through the use of the above embodiments is an in-plane switching (IPS) type liquid crystal display device. However, the present invention may be applied not only to the IPS type but also to a vertical alignment (VA) type liquid crystal display device or to a twisted nematic (TN) type liquid crystal display device.

What is claimed is:

1. A liquid crystal display device comprising
a liquid crystal display panel comprising a thin-film transistor (TFT) substrate having pixels formed thereon in a display area, a counter substrate, and liquid crystal sandwiched between the thin-film transistor substrate and the counter substrate, and the display area being curved along a first axis;
wherein the gap between the TFT substrate and the counter substrate is determined by spacers between the thin-film transistor substrate and the counter substrate;
the spacers are arranged at positions corresponding to a light shielding film on the counter substrate; and
the center of each of the spacers is displaced from the center of each of the corresponding positions of the light shielding film in the direction of the first axis.

2. The liquid crystal display device according to claim 1, wherein, when the liquid crystal display panel is curved toward the TFT substrate, the center of each of the spacers is displaced outwardly of the display area from the center of each of the corresponding positions of the light shielding film in the first axis direction.

3. The liquid crystal display device according to claim 1, wherein, in the first axis direction, the center of each of the spacers is displaced from the center of each of the corresponding positions of the light shielding film by an amount that increases progressively from the center of the display area toward the periphery of the display area.

4. A liquid crystal display device comprising
a liquid crystal display panel comprising a thin-film transistor (TFT) substrate having pixels formed thereon in a display area, a counter substrate, and liquid crystal sandwiched between the thin-film transistor substrate and the counter substrate, and the display area being curved along a first axis;
wherein the TFT substrate has a first spacer formed thereon, the first spacer having a long side dimension oriented in the first axis or a second axis which is perpendicular to the first axis;
the counter substrate has a second spacer formed thereon, the second spacer having a long side dimension oriented in the second axis or of the first axis in a manner crossing the first spacer in a plan view; and
the first spacer or the second spacer having the long side dimension oriented in the first axis is longer than the first spacer or the second spacer having the long side dimension oriented in the second axis.

5. The liquid crystal display device according to claim 4, wherein the first spacer or the second spacer having the long side dimension oriented in the first axis has the center of the long side dimension displaced toward the periphery of the display area from the center of a short side dimension of the second spacer or the first spacer having the long side dimension oriented in the second axis.

6. The liquid crystal display device according to claim 5, wherein the first spacer or the second spacer having the long side dimension oriented in the first axis has the center of the long side dimension displaced toward the display area periphery from the center of the short side dimension of the second spacer or the first spacer having the long side dimension thereof oriented in the second axis, the displacement increasing progressively from the center of the display area toward the display area periphery.

7. A liquid crystal display panel comprising a TFT substrate having first pixels formed thereon in a matrix pattern and a counter substrate having second pixels formed thereon in a manner corresponding to the first pixels, liquid crystal sandwiched between the TFT substrate and the counter substrate to constitute a display area of which a second axis is perpendicular to a first axis thereof;
wherein the liquid crystal display panel is bent into a curved shape along the first axis; and
the center of each of the second pixels in the direction of the first axis is displaced from the center of each of the first pixels in the first axis direction.

8. The liquid crystal display panel according to claim 7, wherein the displacement between the center of each of the second pixels in the first axis direction and the center of each of the first pixels in the first axis direction increases progressively from the center of the display area toward the periphery of the display area.

9. The liquid crystal display panel according to claim 8, wherein the displacement between the center of each of the second pixels in the first axis direction and the center of each of the first pixels in the first axis direction increases progressively from the display area center toward the display area periphery, the progressively increasing displacement being defined by a quadratic function regarding the distance from the center in the first axis direction.

10. The liquid crystal display panel according to claim 8, wherein the displacement between the center of each of the second pixels in the first axis direction and the center of each of the first pixels in the first axis direction increases progressively from the display area center toward the display area periphery, the progressively increasing displacement being linear relative to the distance from the center in the first axis direction.

11. A liquid crystal display device comprising the liquid crystal display panel according to claim 7, wherein the display area is curved.
